(19) United States
(12) Patent Application Publication
(10) Pub. No.: US 2012/0026887 A1
(43) Pub. Date: Feb. 2, 2012

(54) Detecting Rogue Access Points

(76) Inventor: Ramprasad Vempati, Bangalore (IN)

(21) Appl. No.: 12/847,899

(22) Filed: Jul. 30, 2010

(51) Int. Cl. H04L 12/26

(52) U.S. Cl. 370/241

(57) ABSTRACT

Detecting rogues in a controller-based wireless network impersonating the BSSIDs of known valid access points (APs). Access points (APs) and Air Monitors (AMs, receive-only devices) periodically build RF-neighbor lists by collecting the BSSIDS of all the access points they can receive. These lists are then sent to the host controller. The host controller compares the new RF-neighbor list against the old RF-neighbor list. An otherwise valid BSSID appearing on a RF-neighbor list where it has not appeared before is flagged as a potential rogue.

### BACKGROUND OF THE INVENTION

The present invention relates to wireless digital networks, and in particular, to detecting a rogue access point (AP) which is impersonating the BSSID of a valid access point.

APs advertise services by broadcasting different BSSIDs; each BSSID represents a different service, and is based on the MAC address of the radio in the AP.

Rogue devices may be present in a wireless network, impersonating other devices, as an example to capture security credentials of users.

As an example, assume a branch office has two separate areas, each with its own AP, each AP having its own BSSID, for example AP1 with BSSID1 and AP2 with BSSID2. Assume further that the AP1 and AP2, broadcasting BSSID1 and BSSID2, cannot hear each other.

If a rogue device starts using BSSID1 while in the neighborhood of AP1 broadcasting BSSID1, this can be detected by AP1 and flagged.

But if a rogue starts using BSSID1 in the vicinity of AP2 broadcasting BSSID2, even reporting that back to a central controller which controls AP1 and AP2 will not detect the rogue, as BSSID1 is a valid BSSID.

What is needed is a way of detecting rogues operating in different locations.

### BRIEF DESCRIPTION OF THE DRAWINGS

The invention may be best understood by referring to the following description and accompanying drawings that are used to illustrate embodiments of the invention in which:

FIG. 1 shows clients in a wireless network.

### DETAILED DESCRIPTION

Embodiments of the invention relate to methods of detecting rogue devices impersonating the BSSIDs of known access points (APs) in controller-based wireless networks.

According to the present invention, access points (APs) and air monitors (AMs) periodically form RF-neighbor lists by recording beacon frames from nearby APs. These RF-neighbor lists contain the BSSIDs of the nearby APs. These RF-neighborhood lists are communicated periodically to the controller which operates the group of APs.

According to the present invention, changes in RF-neighborhood maps of APs are suspicious and flagged as possible rogues. As an example, if a rogue starts impersonating BSSID1 in the RF-neighborhood of AP2, the next time AP2 does an RF-neighborhood scan, it will detect the rogue broadcasting using BSSID1. When AP2 sends this RF-neighborhood list to its controller, the controller will detect as a change the presence of BSSID1 where it was not present before, and flag this as a potential rogue.

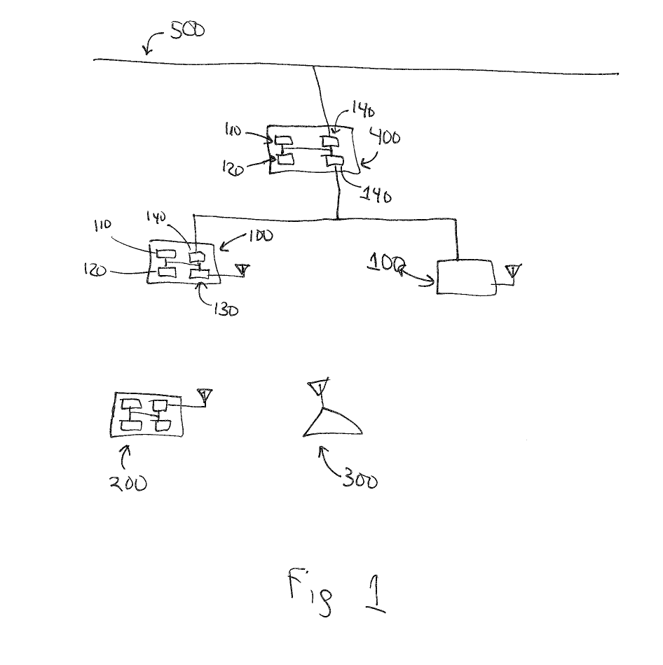

FIG. 1 shows a network in which access points (APs) 100 are purpose-made digital devices, each containing a processor 110, memory hierarchy 120, and input-output interfaces 130. In one embodiment of the invention, a MIPS-class processor such as those from Cavium or RMI is used. Other suitable processors, such as those from Intel or AMD may also be used. The memory hierarchy 120 traditionally comprises fast read/write memory for holding processor data and instructions while operating, and nonvolatile memory such as EEPROM and/or Flash for storing files and system startup information. Wired interfaces 140 are typically IEEE 802.3 Ethernet interfaces, used for wired connections to other network devices such as switches, or to a controller. Wireless interfaces 130 may be WiMAX, 3G, 4G, and/or IEEE 802.11 wireless interfaces. In one embodiment of the invention, APs operate under control of a LINUX operating system, with purpose-built programs providing host controller and access point functionality. Access points 100 typically communicate with a controller 400, which is also a purpose-built digital device having a processor 110, memory hierarchy 120, and commonly a plurality of wired interfaces 140. Controller 400 provides access to network 500, which may be a private intranet or the public internet.

Client devices 200 and rogue 300 have similar architectures, chiefly differing in input/output devices; a laptop computer will usually contain a large LCD, while a handheld wireless scanner will typically have a much smaller display, but contain a laser barcode scanner. A laptop computer makes a good rogue.

As is known to the art, access points 100 advertise to clients through broadcasting BSSIDs. These BSSIDs are based on the AP's MAC, as is known to the art.

According to the present invention, APs and Air Monitors (AMs), which are receive-only devices, periodically scan one or more channels and generate an RF-neighbor list, comprising the BSSIDs of all other APs the AP or AM can receive. As APs in a building are generally fixed devices, mounted to walls and ceilings, the assumption is that these RF-neighbor lists are relatively static.

According to the present invention, the APs and AMs connected to controller 400 periodically transfer their RF-neighbor lists to the controller; controller 400 compares the new list from a particular AP to the old list from that AP. New BSSIDs appearing in an RF-neighbor list are suspicious; in a controller-based wireless network, the controller by definition knows all the BSSIDs in use.

The transfer of RF-neighbor list from AP or AM to controller 400 may be accomplished by having the AP or AM periodically transmit the RF-neighbor list to controller 400, or may be accomplished by controller 400 polling connected APs and AMs for their RF-neighbor list. Optionally, controller 400 may request an AP or AM scan a particular channel or multiple channels to build the RF-neighbor list.

According to the present invention, the presence of an otherwise valid BSSID in a different RF-neighborhood map, one in which that BSSID has not appeared previously, is suspicious and flagged as a potential rogue.

The potential rogue status may be cross-checked with other information kept by controller 400. As an example, if controller 400 knows that BSSID1 is assigned to AP1 and is operating on channel 6, having BSSID1 appear on channel 11 for the first time in the RF-neighbor map of AP2 would be flagged as a potential rogue.

The present invention may be realized in hardware, software, or a combination of hardware and software. The present invention may be realized in a centralized fashion in one computer system such as controller 400, or in a distributed fashion where different elements are spread across several interconnected computer systems. A typical combination of hardware and software may be a controller or access point with a computer program that, when being loaded and executed, controls the device such that it carries out the methods described herein.

The present invention also may be embedded in nontransitory fashion in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

I claim:

1. In a wireless digital network having a plurality of access points (AP) and/or air monitors (AM) connected to a controller, the method of detecting potential rogue wireless devices comprising:
at each AP or AM, building a RF-neighbor list of all the BSSIDs that AP or AM can receive,
transferring the RF-neighbor list to the controller,
comparing, at the controller, the RF-neighbor list transferred from an AP or AM to the last RF-neighbor list transferred to the controller from that AP or AM, and
flagging as a potential rogue any BSSID present in the RF-neighbor list transferred from the AP or AM that is not present in the last RF-neighbor list transferred to the controller from that AP or AM.

2. The method of claim 1 where the RF-neighbor list is transferred from the AP or AM to the controller on a periodic basis.

3. The method of claim 1 where the RF-neighbor list is transferred from the AP or AM to the controller in response to polling by the controller.

4. The method of claim 1 where the process of building a RF-neighbor list includes the step of scanning multiple channels for BSSIDs.

5. A machine readable medium having a set of instructions stored in nontransitory form therein, which when executed on devices connected to a network cause a set of operations to be performed comprising:
building a RF-neighbor list of all BSSIDs received by an access point or air monitor connected to the network,
transferring the RF-neighbor list from the access point or air monitor to the controller hosting the access point or air monitor,
comparing, at the controller, the RF-neighbor list from the access point or air monitor with the last RF-neighbor list transferred to the controller from that access point or air monitor, and
flagging as a potential rogue any BSSID present in the RF-neighbor list transferred from the access point or air monitor that is not present in the last RF-neighbor list transferred to the controller from that access point or air monitor.
